(19) United States
(12) Patent Application Publication
(10) Pub. No.: US 2005/0126029 A1
(43) Pub. Date: Jun. 16, 2005

(54) Wire measuring system

(76) Inventors: Juan Bautista, Laguna Hills, CA (US); Joshua Bethmann, Laguna Hills, CA (US)

Correspondence Address: GOLDSTEIN LAW OFFICES, P.C., 2071 CLOVE ROAD - 204, STATEN ISLAND, NY, 10304, US

(21) Appl. No.: 09/844,593

(22) Filed: Apr. 27, 2001

(51) Int. Cl. G01B 3/10

(52) U.S. Cl. 33/758

(57) ABSTRACT

A wire measuring system including a housing having a handle secured thereto. The housing has a hollow interior including an exit slot formed therein. A length of tape is disposed within the hollow interior of the housing. The length of tape has incremental measurements imprinted thereon. The length of tape has a free end extending outwardly of the exit slot of the housing. A tip portion is swively coupled with the free end of the length of tape. The tip portion has a slot formed therethrough for receiving a free end of a length of wire therethrough.

### BACKGROUND OF THE INVENTION

The present invention relates to a wire measuring system and more particularly pertains to ensuring a proper length of wire prior to cutting.

The use of measuring tool devices is known in the prior art. More specifically, measuring tool devices heretofore devised and utilized for the purpose of providing proper measurements are known to consist basically of familiar, expected and obvious structural configurations, notwithstanding the myriad of designs encompassed by the crowded prior art which have been developed for the fulfillment of countless objectives and requirements.

By way of example, U.S. Pat. No. 4,092,780 to Trethway and U.S. Pat. No. 6,016,609 to Donovan disclose electrician's fish tape with a means for measuring the distance of the tape using a counter device. U.S. Pat. No. 5,056,731 to Koehn and U.S. Pat. No. 5,423,516 to Blaha disclose additional fish tape reel devices.

While these devices fulfill their respective, particular objective and requirements, the aforementioned patents do not describe a wire measuring system for ensuring a proper length of wire prior to cutting.

In this respect, the wire measuring system according to the present invention substantially departs from the conventional concepts and designs of the prior art, and in doing so provides an apparatus primarily developed for the purpose of ensuring a proper length of wire prior to cutting.

Therefore, it can be appreciated that there exists a continuing need for a new and improved wire measuring system which can be used for ensuring a proper length of wire prior to cutting. In this regard, the present invention substantially fulfills this need.

### SUMMARY OF THE INVENTION

In the view of the foregoing disadvantages inherent in the known types of measuring tool devices now present in the prior art, the present invention provides an improved wire measuring system. As such, the general purpose of the present invention, which will be described subsequently in greater detail, is to provide a new and improved wire measuring system which has all the advantages of the prior art and none of the disadvantages.

To attain this, the present invention essentially comprises a circular housing having a handle radially secured thereto. The circular housing has a hollow interior including an exit slot formed therein. A length of tape is disposed within the hollow interior of the circular housing. The length of tape has incremental measurements imprinted thereon. The length of tape has a free end extending outwardly of the exit slot of the circular housing. A tip portion is swively coupled with the free end of the length of tape. The tip portion has a slot formed therethrough for receiving a free end of a length of wire therethrough.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved wire measuring system which has all the advantages of the prior art measuring tool devices and none of the disadvantages.

It is another object of the present invention to provide a new and improved wire measuring system which may be easily and efficiently manufactured and marketed.

It is a further object of the present invention to provide a new and improved wire measuring system which is of durable and reliable construction.

An even further object of the present invention is to provide a new and improved wire measuring system which is susceptible of a low cost of manufacture with regard to both materials and labor, and which accordingly is then susceptible of low prices of sale to the consuming public, thereby making such a wire measuring system economically available to the buying public.

Even still another object of the present invention is to provide a new and improved wire measuring system for ensuring a proper length of wire prior to cutting.

Lastly, it is an object of the present invention to provide a new and improved wire measuring system including a housing having a handle secured thereto. The housing has a hollow interior including an exit slot formed therein. A length of tape is disposed within the hollow interior of the housing. The length of tape has incremental measurements imprinted thereon. The length of tape has a free end extending outwardly of the exit slot of the housing. A tip portion is swively coupled with the free end of the length of tape. The tip portion has a slot formed therethrough for receiving a free end of a length of wire therethrough.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the wire measuring system constructed in accordance with the principles of the present invention.

FIGS. 2 through 8 illustrate a sequential use of the present invention.

The same reference numerals refer to the same parts through the various figures.

### DESCRIPTION OF THE PREFERRED EMBODIMENT

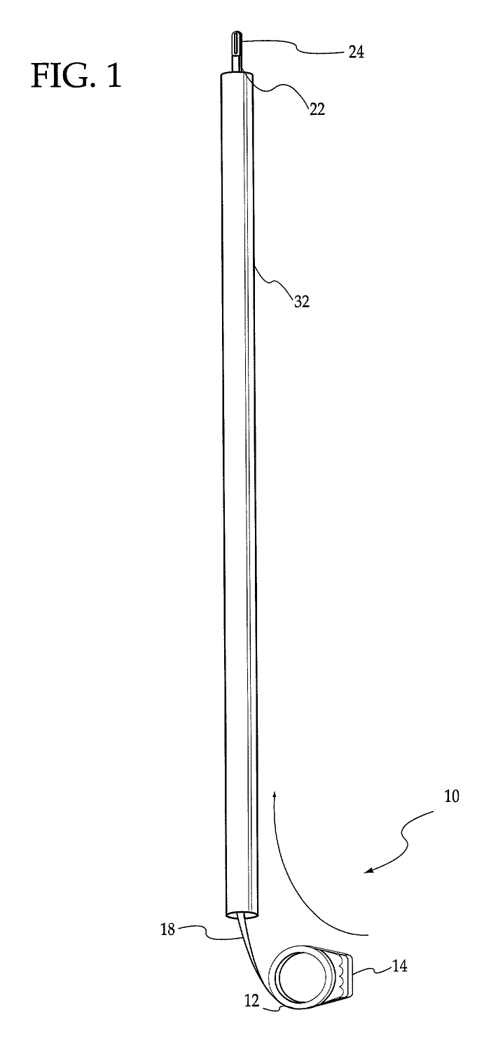

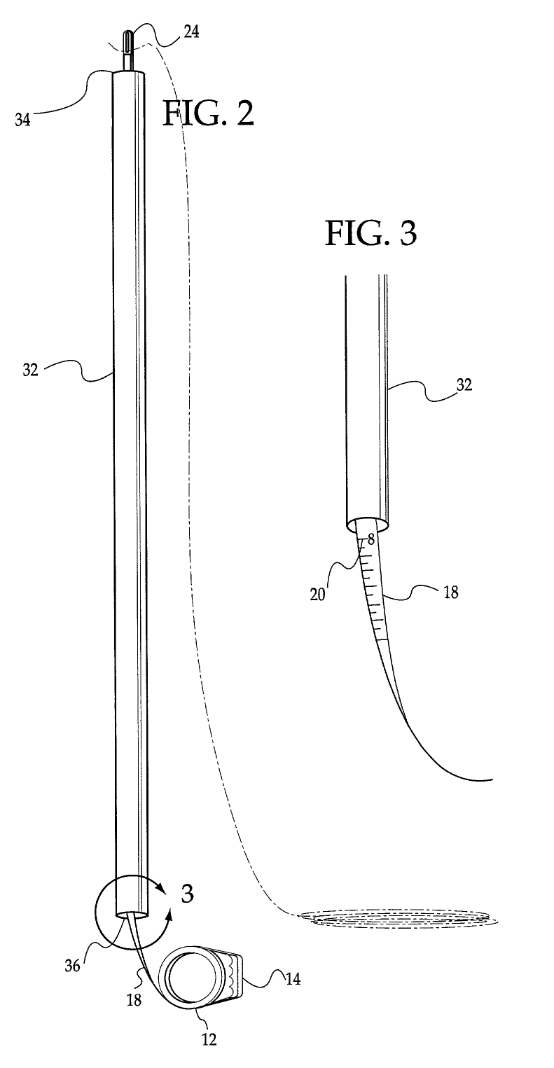

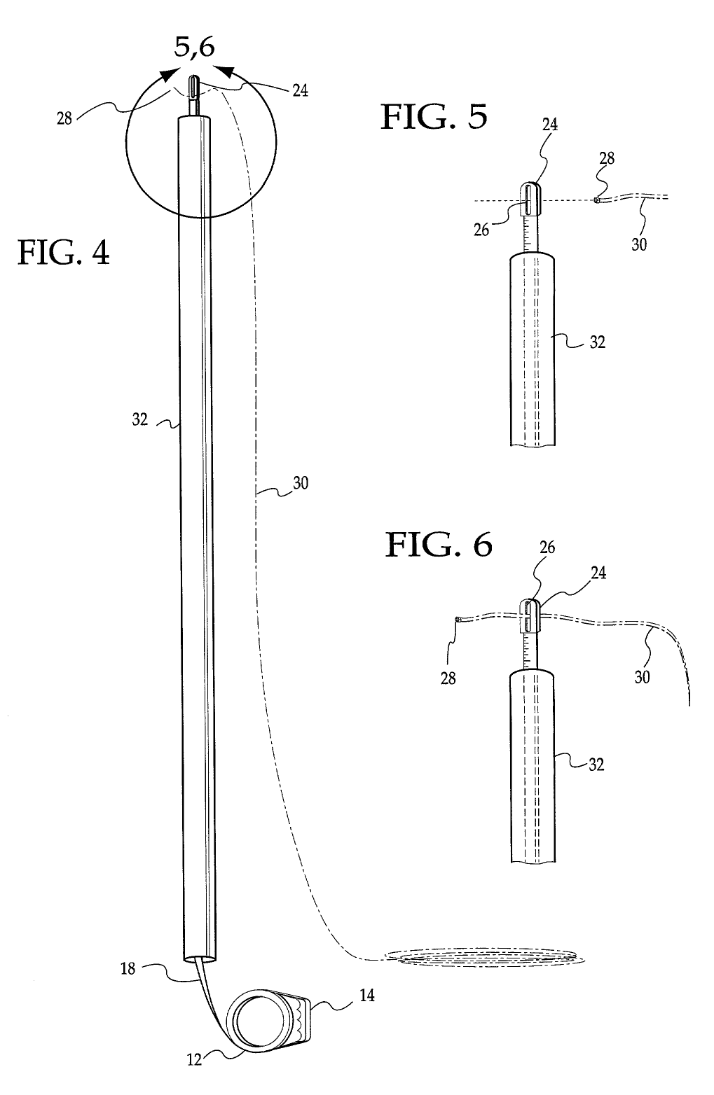

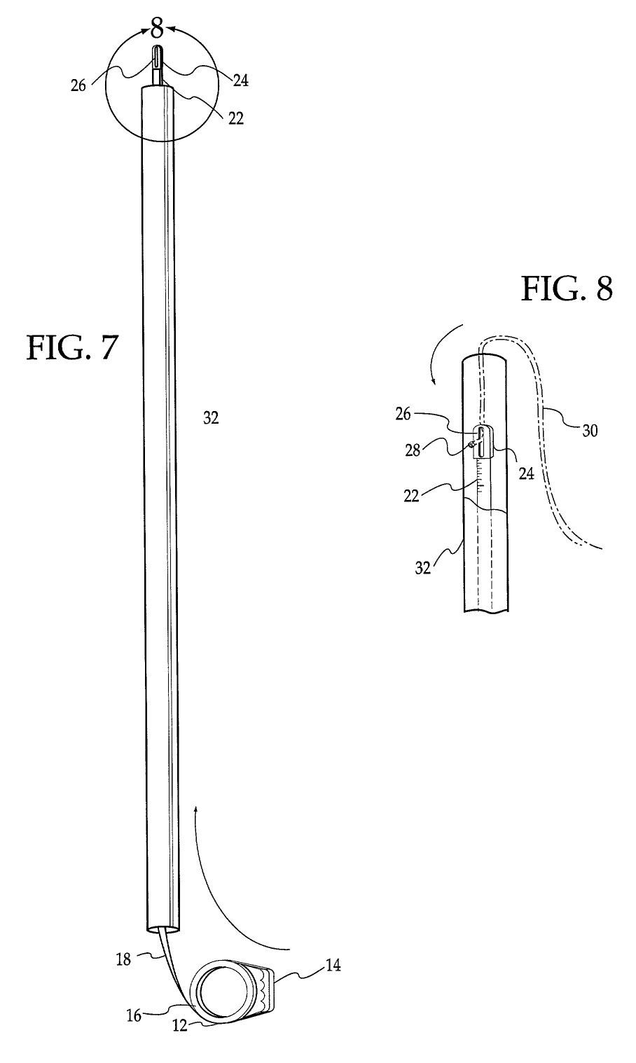

With reference now to the drawings, and in particular, to FIGS. 1 through 8 thereof, the preferred embodiment of the new and improved wire measuring system embodying the principles and concepts of the present invention and generally designated by the reference number 10 will be described.

Specifically, it will be noted in the various Figures that the device relates to a wire measuring system for ensuring a proper length of wire prior to cutting. In its broadest context, the device consists of a circular housing, a length of tape, and a tip portion. Such components are individually configured and correlated with respect to each other so as to attain the desired objective.

The circular housing 12 has a handle 14 radially secured thereto. The circular housing 12 has a hollow interior including an exit slot 16 formed therein.

The length of tape 18 is disposed within the hollow interior of the circular housing 12. The length of tape 18 has incremental measurements 20 imprinted thereon. The length of tape 18 has a free end 22 extending outwardly of the exit slot 16 of the circular housing 12.

The tip portion 24 is swively coupled with the free end 22 of the length of tape 18. The tip portion 24 has a slot 26 formed therethrough for receiving a free end 28 of a length of wire 30 therethrough.

In use, the length of tape 18 of the present invention will be extended through a length of conduit 32. The free end 22 of the length of tape 18 will be extended outwardly of an open distal end 34 of the conduit 32. Once this has been accomplished, the free end 28 of the length of wire 30 is extended into the slot 26 of the tip portion 24. The length of tape 18 is then pulled back out through the conduit 32 in a reversed direction until the length of wire 30 is pulled through a proximate end 36 of the conduit whereupon it can be cut so that a proper cut of wire is measured.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

1. A wire measuring system for ensuring a proper length of wire prior to cutting comprising, in combination:
a circular housing having a handle radially secured thereto, the circular housing having a hollow interior including an exit slot formed therein;
a length of tape disposed within the hollow interior of the circular housing, the length of tape having incremental measurements imprinted thereon, the length of tape having a free end extending outwardly of the exit slot of the circular housing; and
a tip portion swively coupled with the free end of the length of tape, the tip portion having a slot formed therethrough for receiving a free end of a length of wire therethrough.

2. A wire measuring system for ensuring a proper length of wire prior to cutting comprising, in combination:
a housing having a handle secured thereto, the housing having a hollow interior including an exit slot formed therein;
a length of tape disposed within the hollow interior of the housing, the length of tape having incremental measurements imprinted thereon, the length of tape having a free end extending outwardly of the exit slot of the housing; and
a tip portion swively coupled with the free end of the length of tape, the tip portion having a slot formed therethrough for receiving a free end of a length of wire therethrough.
